(19) United States
(12) Patent Application Publication
(10) Pub. No.: US 2007/0048403 A1
(43) Pub. Date: Mar. 1, 2007

(54) Modular mobile dairy plant

(76) Inventors: Theodore J. Thuli, Darlington, WI (US); Anthony J. Thuli, Darlington, WI (US); Torrence E. Thuli, Darlington, WI (US)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 11/511,601

(22) Filed: Aug. 29, 2006

Related U.S. Application Data
(60) Provisional application No. 60/713,139, filed on Aug. 31, 2005.

(51) Int. Cl. A23C 9/12

(52) U.S. Cl. 426/36

(57) ABSTRACT

The present invention is a modular, self-contained, mobile dairy-processing plant capable of producing cheese and other dairy products from raw milk stored within the device and able to be moved to various locations in a simple and easy manner using various systems constructed in the mobile plant. The plant takes the form of a trailer connectable to a semi-tractor for transportation of the trailer to any number of locations. The trailer includes storage tanks for holding raw milk, potable water for use in the dairy processing, and for containing gray water and other waste products generated by the plant for later disposal. For a cheese-making plant configuration, the trailer includes a C.I.P. batch pasteurization unit, a multipurpose make vat, a multipurpose finishing table and a brine tank that are used to form various cheeses from the milk held within the storage container on the device. The trailer also includes an observation deck capable of allowing an individual to view the cheese-making process through the exterior of the trailer, a retail area for selling the cheese, a storage area for storing the cheese made in the trailer, and a mechanical area enclosing the various mechanical components utilized in the operation of the plant. The heated and cooled water streams employed by the plant are closed loop systems that avoid creation of additional waste and contamination of the in-process cheese.

### CROSS-REFERENCE TO RELATED APPLICATION

This application claims priority under 35 U.S.C. §119(e) to U.S. Provisional Application Ser. No. U.S. Ser. No. 60/713,139, filed Aug. 31, 2005.

### FIELD OF THE INVENTION

The present invention relates to cheese making, and more specifically to a self-contained, mobile dairy plant for making cheese.

### BACKGROUND OF THE INVENTION

In order to manufacture cheese from milk, a cheese processing plant is normally utilized to convert the milk through various steps into cheese. The processing plant includes a number of different types of machinery that are utilized within the plant to process the milk and other necessary components for making cheese through the various steps in order to manufacture the cheese. This machinery normally includes milk pasteurization equipment, cheese make vats used for the formation of curds and whey from the pasteurized milk and other added ingredients, such as bacteria cultures, which are subsequently separated to remove the curds from the whey, and then pressed on a suitable finishing table in order to form the cheese.

However, previously, in order to manufacture cheese on a commercial scale, the size of the components utilized required a large, fixed-site processing plant to be constructed, requiring great expense and time. Also, as different types of cheese require different types or variations of the cheese making machinery, in order to be able to make these different types of cheese in a single plant, even more equipment is required, with an associated greater expense. As a result, the ability to commercially make and sell cheese is beyond the means of many individuals that produce the raw materials for making cheese, such as dairy farmers. Therefore, it is desirable to develop an apparatus and method for use in making cheese products that is extremely compact with regard to the prior art cheese-making plants that are known and that also can be utilized by a number of different individuals for making cheese, such as by making the apparatus mobile.

### SUMMARY OF THE INVENTION

According to a primary aspect of the present invention, a modular dairy processing, and preferably a cheese-making apparatus is provided in which the apparatus is entirely enclosed within a mobile trailer capable of being attached to a vehicle for movement of the trailer between locations. The trailer includes a cheese making area in which all of the required cheese-making or other dairy processing machinery, namely, a milk pasteurizer, a cheese-make vat, and a cheese finishing apparatus, is contained such that the entire cheese-making process can be carried out in the cheese-making area. The trailer also includes a number of storage containers attached to the trailer and connected to the machinery in the cheese-making area. These containers are capable of holding milk and potable water to be used in the cheese-making process, such that all of the materials required for the entire cheese-making process are contained within the trailer. Further, the trailer also includes a chilled storage area for the cheese made within the cheese-making are of trailer, such that the cheese can be stored within the trailer for further conditioning and/or preservation of the cheese. Also, the trailer can optionally include a retail area from which the cheese made in the cheese-making area and/or stored in the storage area can be sold directly from the trailer.

According to another aspect of the present invention, all of the electrical and mechanical system connections between the various dairy processing machinery disposed within the cheese-making area of the trailer are not connected to any source outside of the trailer, such that all of the raw materials used and waste created by the apparatus is contained exclusively within the trailer during all phases of the dairy processing occurring within the trailer. Additionally, many of the systems utilized in the cheese-making and storage areas of the trailer are closed loop systems, such that the cheese-making and storage areas within the trailer generate much less waste than a conventional dairy processing plant.

According to still another aspect of the invention, the apparatus includes an observation deck disposed on the exterior of the trailer to enable individuals on the exterior of the trailer to view the various stages of the cheese-making process or other diary processing occurring within the trailer for educational or various other purposes. The observation deck can also be utilized as a sales area in addition to observing the process of cheese-making within the trailer by providing an additional location adjacent the observation deck through which cheese made within the trailer can be purchased from the retail are in the trailer by individuals on the deck.

Numerous other aspects, features, advantages and objects of the present invention will be made apparent from the following detailed description taken together with the drawing figures.

### BRIEF DESCRIPTION OF THE DRAWINGS

The drawings illustrate the best mode currently contemplated as practicing the present invention.

In the drawings:

FIG. 1 is an isometric view of the modular dairy processing apparatus of the present invention;

FIG. 2 is a side view of the apparatus of FIG. 1;

FIG. 3 is a cross-sectional view along line 3-3 of FIG. 2;

FIG. 4 is a side plan view of a vat pasteurizer utilized in the device of FIG. 1;

FIG. 5 is a top plan view of the pasteurizer of FIG. 4;

FIG. 6 is an isometric view of a multipurpose finishing table utilized in the apparatus of FIG. 1;

FIG. 7 is an isometric view of a second configuration of the finishing apparatus of FIG. 6;

FIG. 8 is a bottom plan view of the finishing apparatus of FIG. 7;

FIG. 9 is an isometric view of a cheese-make vat utilized in the device of FIG. 1; and

FIG. 10 is a cross-sectional view along line 10-10 of FIG. 9.

### DETAILED DESCRIPTION OF THE INVENTION

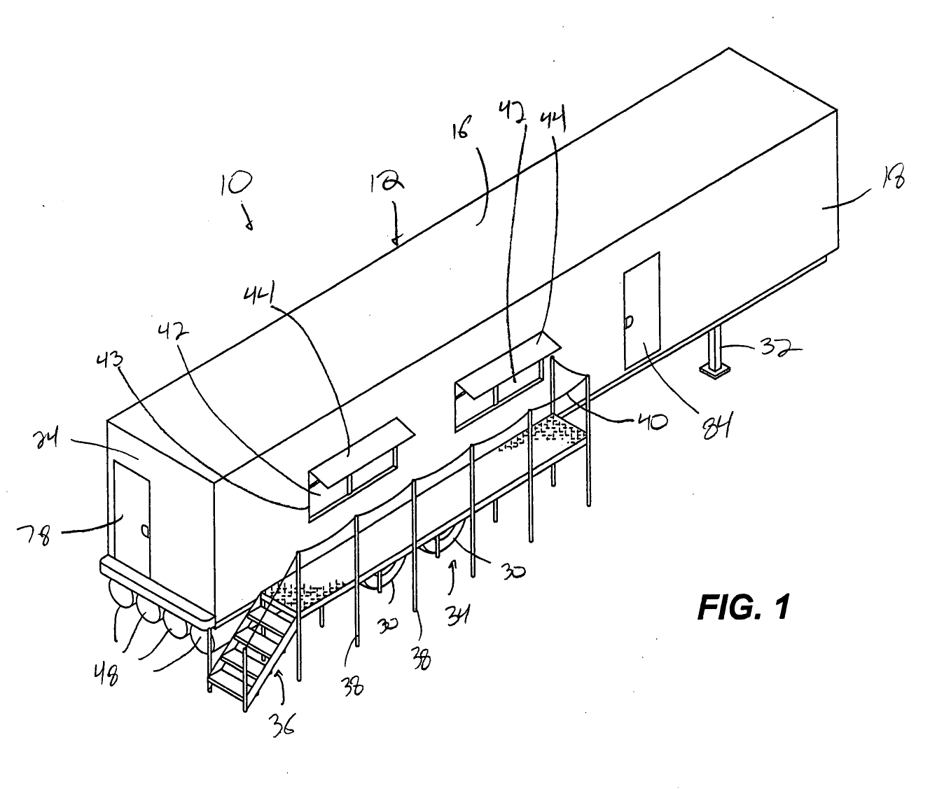

With reference now to the drawing figures in which like reference numerals designate like parts throughout the disclosure, a dairy processing apparatus constructed according to the present invention is indicated generally at 10 in FIG. 1. The apparatus 10 includes a trailer 12 that can be formed of any suitably sized mobile enclosure, but is preferably formed of a standard semi-trailer that is approximately fifty-three (53) feet in length and eight (8) feet in width. The trailer 12 is attachable to a standard semi-tractor (not shown) in order to transport the trailer 12 between a variety of locations, making the apparatus 10 completely mobile.

The trailer 12 includes a generally rectangular box-like exterior 14, including a top wall 16, and pair of side walls 18 and 20 extending downwardly from opposite sides of the top wall 16, a front wall 22 extending downwardly from the top wall 16 and joining adjacent ends of the side walls 18 and 20, a rear wall 24 extending downwardly from the top wall 16 opposite the front wall 22 and joining the opposite ends of the side walls 18 and 20, and a bottom wall 26 extending between the side walls 18 and 20, the front wall 22 and the rear wall 24 opposite the top wall 16 to define an interior 46 for the trainer 12. The various interior surfaces of the walls of the trailer 12 are formed of a suitable lightweight, waterproof material, such as stainless steel, plastic, or a combination thereof, among others, that enables the trailer 12 to be moved easily and that allows the interior 46 of the trailer 12 to be cleaned simply by spraying the interior 46 with water when necessary. In a particularly preferred arrangement, the bottom wall 26 includes a stainless steel floor, and most preferably a diamond plate stainless steel floor, while the side walls 18 and 20 and the top wall 16 include exposed washable plastic surfaces. Also, the arrangement of the various components of the apparatus 10 in the trailer 12 do not require any openings to be cut through the top wall 16, thus eliminating potential leakage problems through the top wall 16.

The bottom wall 26 is connected opposite the interior 46 to a trailer support frame 28. The support frame 28 is in turn attached to a wheel frame 29 to which are rotatably supported two pairs of wheels 30 adjacent the rear wall 24. The trailer frame 28 also includes a supporting jack 32 spaced from the wheels 30 adjacent the front wall 22 and operable to support the front of the trailer 12 when the trailer 12 is not connected to a semi-tractor. In order to position the trailer 12 in a level configuration on a selected supporting surface, the frame 28 may also include leveling devices to illustrate the position of the trailer 12 with respect to a completely horizontal position.

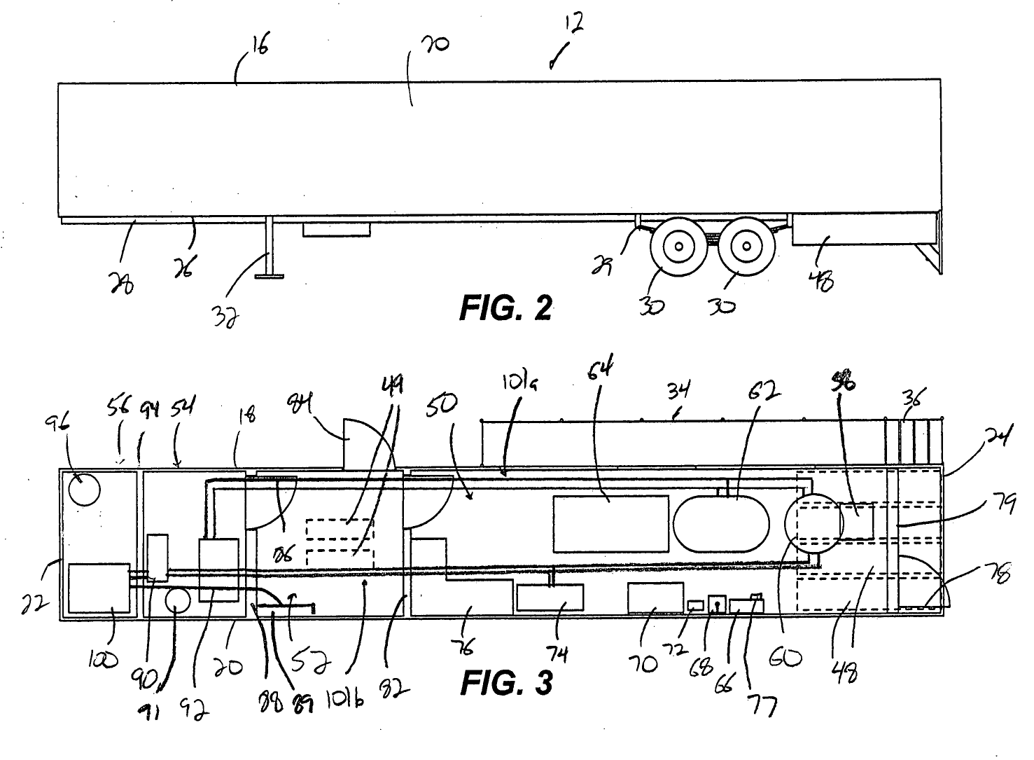

Referring now to FIGS. 1-3, the trailer 12 also includes an observation deck 34 extending generally perpendicularly from side wall 18, though the deck 34, or an additional deck 34, could be located on side wall 20 as well. The deck 34 is releasably secured to the side wall 18 by any conventional means, such as suitable brackets (not shown), and includes a ramp or stair case 36 at one end adjacent the rear wall 24, and a number of supports 38 spaced therealong opposite side wall 18 in order to support the deck 34 in relation to the trailer 12. The supports 38 preferably extend from the ground (not shown) on which the trailer 12 and supports 38 are resting above the level of the deck 34, such that the supports 38 can also include a railing member 40 in order to provide additional support to individuals utilizing the deck 34. The deck 34 and stairs 36 can be separated from one another for storage within the trailer 12 when the apparatus 10 is being moved. Also, the deck 34 can be formed as any number of individual pieces (not shown) of a suitable material, such as wood, metal grating, or stainless steel, among others, that are each connectable to one another and to the trailer 12 to form the deck 34. Other optional features, such as outdoor lights (not shown) and additional entry steps or ramps (not shown) attachable to the deck 34 or the trailer 12 can also be included with the trailer 12.

The deck 34 is positioned immediately beneath a pair of windows 42 located on the side wall 18. The windows 42 are disposed within openings 43 in the side wall 18 and have any suitable conventional construction. The windows 42 include selectively closable shutters 44 that are movably, and preferably pivotably secured to the side wall 18 to form a virtually seamless surface to side wall 18 when in the closed position, but also to provide a relatively unobstructed view through the windows 42 in the open position, as shown in FIG. 1. When the shutters 44 are in the position as shown in FIG. 1, individuals standing on the deck 34 can look through the windows 42 into the interior 46 of the trailer 12 in order to view the cheese-making process occurring therein.

The trailer 12 also includes a number of storage tanks 48 secured to the trailer frame 28 below the bottom wall 26 generally adjacent the rear wall 24. Each of the tanks 48 is formed of a durable, relatively lightweight and waterproof material, such as stainless steel, and preferably generally cylindrical in shape, but can have any desired configuration. The tanks 48 are secured to the frame 28 to extend along the frame 28 from the rear wall 24 to a position immediately rearward of the wheels 30 and are capable of holding an amount of milk or potable water to be utilized by the apparatus 10, or an amount of waste or gray water or whey generated by the cheese-making process occurring in the apparatus 10 that can later be discharged from the tanks 48 for proper disposal. Further, additional tanks 49 can be located on the frame 28, such as propane tanks used to heat water for use in the dairy processing occurring within the trailer 12, such as a cheese-making process, among others.

Referring now to FIG. 3, the interior 46 of the trailer 12 is separated into a number of different areas, namely, a dairy processing area 50, a cooler area 52, a utility area 54, and a mechanical area 56. The dairy processing area 50 is the area of the trailer 12 in which the cheese-making process or other dairy processing occurs by processing milk into various products, such as cheese, as desired. The dairy processing area 50 houses one or more pumps 58 that is operably connected to one or more of the storage tanks 48 that preferably contain the milk to be utilized in the cheese-making process of the preferred embodiment of the apparatus 10 of the present invention, and to a batch pasteurizer 60. The dairy processing area 50 in the particularly preferred cheese-making embodiment also includes a cheese-make vat 62 and a multi-purpose finishing table 64. Also included in area 50 are a chart recorder 66 operably connected to the pasteurizer 60, a sink 68, a wash tank 70, and a hose connection 72 to be utilized with or separately from the sink 68 and tank 70. The hose connection 72 can be utilized to clean one or more of the pasteurizer 60, vat 62 and table 64, as well as the storage tanks 48, such as through the use of sprayballs (not shown) connected to the hose 72 and positionable in these components. Area 50 also includes a brine tank 74, and a utility table 76 that can be mounted to the bottom wall 26, or to one of the side walls 18 or 20 in a fixed or pivotable manner. A control panel 77 is also provides that is operably connected to and used to control the operation of the pump 58, pasteurizer 60, vat 62, and finishing table 64. Access to the area 50 can be obtained through a door 78 positioned in the rear wall 24 of the trailer 12 (FIG. 1), or in a partition 79 spaced inwardly from the rear wall 24 within the interior 46 of the trailer 12 that defines an outer wall for the dairy processing area 50 (FIG. 3). The dairy processing area 50 also includes a partition 82 defining the inner wall of the area 50 opposite the partition 79. The partition 82 includes a door 80 extending through a partition 82 to allow access between the dairy processing area 50 and the cooler area 52 within the trailer 12. The exposed surfaces of each of the doors 78 and 80, and the partition 82 within the cheese-making area 50 are formed with a material similar to that used for the interior surfaces of the walls 16-24, such that the cheese-making area 50 can be cleaned in a simple manner by spraying the exposed surfaces of the area 50 with wash water. A drain (not shown) is disposed in the floor of the area 50, such that dirty wash water may flow out of the area 50 through the drain, such as to one or more of the storage tanks 48 for collection and later disposal.

The cooler area 52 is a refrigerated storage area in which cheese formed in area 50 can be placed for curing and/or storage until sale and enables the cheese made within the apparatus 10 to be stored within the trailer 12 once it is made. As stated previously, the storage area 52 is accessible through the door 80 connecting the dairy processing area 50 and the storage area 52, or through a separate door 84 extending through side wall 18 of the trailer 12 that provides access from the storage area 52 to the exterior of the trailer 12. A number of additional support surfaces or shelves (not shown) can also be positioned on the respective walls of the storage area 52 to hold various items and finished cheeses in the area 52. The storage area 52 also has a partition 88disposed opposite partition 82 in which is located a door 86 that extends through the partition 88 to allow access between the cooler 52 and the utility area 54. The partition 88 separates the storage area 52 from the utility area 54, and preferably is formed similarly to the partition 82 to function as an insulating wall.

A number of chillers 90 capable of cooling the storage area 52 to the desired temperature are positioned within the utility area 54 and are operably connected to a ventilation unit 89 disposed within the storage area 52 to distribute the cooled air from the chillers 90 throughout the storage area 52. The storage area 52 is also formed similarly to the dairy processing area 50, with a floor, side walls and ceiling formed of a waterproof and washable material, such as stainless steel, plastic or a combination thereof to enable the storage area 52 to be cleaned by spraying the area 52 with wash water. The storage area 52 also includes a drain (not shown) that directs the wash water out used to clean the cooler 52 of the storage area 52, such as to one of the storage tanks 48 for collection and later disposal.

The utility area 54 is formed as necessary in order to enclose various operating mechanisms for the apparatus 10, such as the chillers 90 mentioned previously. The utility area 94 also includes a hot water heater 91 and a boiler 92 preferably operably connected to a water storage tank 48 and used to provide a supply of hot water to the various components of the apparatus 10. Further, other mechanisms, such as circuit breakers (not shown), pumps (not shown) and generators (not shown), as well as the associated piping, valves, conduits and switches (not shown) are disposed in the utility area 54 to enable the apparatus 10 to function in a completely self-sufficient manner. However, in a preferred embodiment, the utility area 54 does include a power connection (not shown) for engagement with an exterior power source to supply the necessary electrical power to the apparatus.

A partition 94 separates the utility area 54 from the mechanical area 56 and, in a preferred embodiment, does not include a door, such that the mechanical area 56 is accessible only from an access panel (not shown) disposed on one or more of the side walls 18 or 20, or the front wall 22 of the trailer 12. The mechanical area 56 includes a number of mechanical components, such as a water storage tank 96 which can be operably connected to the hot water heater 91 or boiler 92, or to one of the chillers 90, and a number of compressors 100. The compressors 100 are operably connected to chillers 90 and the ventilation unit 89. The pasteurizer 60 and make vat 62 are connected to the boiler 92 which provides the supply of hot water in a closed loop system via piping system 101a to avoid the contamination of the contents of the pasteurizer 60 and vat 62 and/or waste of the heated water. Additionally, water cooled by the chiller 90 is circulated to the pasteurizer 60 and optionally to the brine tank 74 via piping 101b in order to cool these elements as desired. Circulation of the cooled water is also done in a closed loop manner, such that the cooled water circulated between the pasteurizer 60 and tank 74 does not contaminate the contents of the pasteurizer 60 or brine tank 74, or generate additional waste water. The piping 101a and 101b is constructed in the trailer 12 in order to allow the piping 101a and 101b to be readily attached to and disconnected from a number of different types of dairy processing equipment, to enable the area 50 to be configured as necessary for the desired dairy processing function. Other mechanical components, such as a generator (not shown) used to operate lights (not shown) and other electrical devices, such as the chart recorder 66 and controls 77, and electrical outlets disposed in the various areas 50-56, and an air compressor (not shown), among others, can be placed within either of the utility area 54 or the mechanical area 56 for operating various components of the apparatus 10 that are positioned within the dairy processing area 50 after construction of the trailer 12.

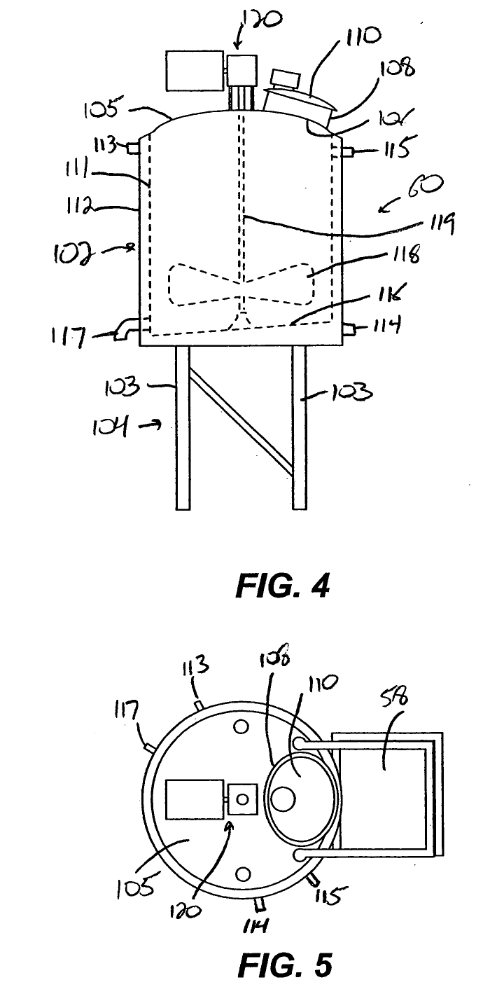

Referring now to FIGS. 4-5, the batch pasteurizer 60 positioned in the cheese-making area 50 is illustrated as including a tank 102 attached to a support 104 having a number of interconnected legs 103 to space the tank 102 above the bottom wall 26 of the trailer 12. The tank 102 is generally cylindrical in shape and formed of a waterproof, durable material, such as stainless steel. The pasteurizer 60 has a generally dome-shaped top end 105 affixed to the tank 102 that includes an opening 106 extending therethrough that is surrounded by a collar 108 which has a cover 110 movably attached thereto.

The tank 102 includes an inner shell 111 spaced from and disposed within an outer shell 112, that are each formed of waterproof materials capable of withstanding the pasteurization temperatures generated within the tank 102, such as stainless steel. The outer shell 112 completely surrounds the inner shell 111 and includes a fluid inlet 113, and a fluid outlet 114 each connected to piping 101a and 101b to receive heated and cooled water from the water boiler 98 and the refrigeration unit 89 to control the operating temperature within the tank 102. The inner shell 111 includes an inlet 115 connected via the pumps 58 to one or more of the storage tanks 48 to enable raw milk from the tank 48 to be pumped into the inner shell 111 for pasteurization. The inner shell 111 also includes a sloped bottom surface 116, best shown in FIG. 4, such that milk introduced into the tank 102 can be dispensed from the inner shell 111 through a fluid outlet or spigot 117 located adjacent the lowermost point of the bottom surface 116. Once the milk in the inner shell 111 has been sufficiently pasteurized utilizing the heated water from the water boiler 98 and cooled using the water from the refrigeration unit 89, the pasteurized milk can flow out of the inner shell 111 through the outlet 117 and into the make vat 62, which has one end positioned directly under the outlet 117, completely under the influence of gravity due to the slope of the bottom surface 116.

During the pasteurization of the milk in the tank 102, the milk, and any additives introduced through the opening 106, are agitated to increase the efficiency of the pasteurization by an impeller 118 disposed within the inner shell 111 adjacent the bottom surface 116 that is connected to a shaft 119 extending out of the tank 102 through the top end 105 and operably connected opposite the impeller 118 to a motor 120. The speed of the motor 120 and corresponding speed of the impeller 118 are controlled by the controls 77 that are operably connected to the motor 120, or by any other suitable automatic or manually operated control means. Further, after all of the pasteurized milk has been drained from the tank 102, the tank 102 can be cleaned in a C.I.P. manner by directing wash water via the pump 58 into the inner shell 111 through the inlet 115, and removing the dirty wash water through the outlet 117 for collection in one of the storage tanks 48 for later disposal.

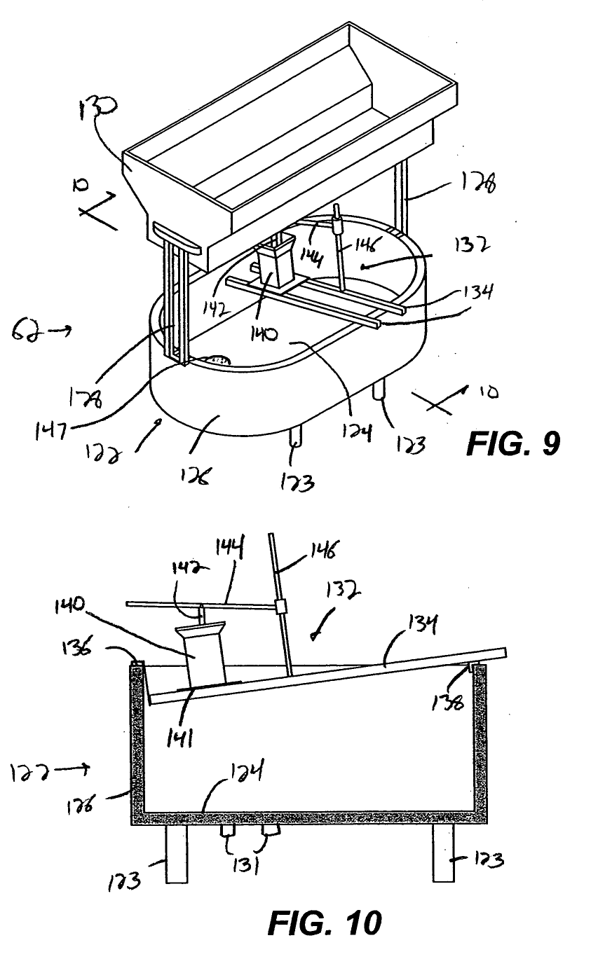

Looking now at FIGS. 9 and 10, the make vat 62 includes a container 122 having a bottom wall 124 connected to a number of downwardly extending supports 123, and a generally oval-shaped side wall 126 extending around the periphery of the bottom wall 124, which are each formed of a waterproof and durable material, such as stainless steel. The side wall 126 is connected opposite the bottom wall 124 to a pair of generally upright columns 128 that are connected opposite the side wall 126 to an agitator housing 130. The agitator housing 130 includes a motor (not shown) operably connected to a shaft (not shown) that extends downwardly from the agitator housing 130 into the container 122 below the level of the side wall 126. The shaft is connected to an impeller (not shown) opposite the motor that can be rotated within the container 122 by the motor. The impeller agitates the pasteurized milk and culture additives held within the container 122 to form curds and whey from the pasteurized milk in a known manner. The agitator housing 130 also includes a mechanism (not shown) that operates either manually or automatically to oscillate the motor, shaft and impeller along the long axis of the housing 130 between opposed ends of the container 122 to more efficiently agitate the pasteurized milk contained within the vat 62. The container 122 also includes fluid connections 131 that enable heated water to flow from the water heater 96 and/or boiler 98 into the interior of the container to heat the milk or curds and whey contained within the container 122.

The make vat 62 also can function as a curd holder through the use of a curd mill 132 releasably attached to the container 122 of the vat 62. The curd mill 132 includes a pair of rails 134 and a pair of brackets 136 and 138 extending between adjacent ends of each rail 134 and engageable with opposed portions of the side wall 126. The rails 134 are spaced from one another and support a housing 140 therebetween that includes a number of blades (not shown) disposed adjacent a lower end 141 of the housing 140, near the rails 134. A plunger 142 is positionable within the housing 140 and can be urged through the housing 140 either manually or automatically to force curds positioned within the housing 140 against the blades, thereby cutting the curds into smaller sections defined by the apertures (not shown) defined between the blades within the housing 140. The plunger 142 is pivotally connected to a handle 144 which, in turn, is movably connected to a support 146 fixedly connected to one the rails 134.

The whey generated by the agitation of the pasteurized milk within the make vat 62 and resulting production of the curds can be removed from the vat 62 through a drain 147 disposed in the bottom wall 124 on the container 122. The drain 147 is preferably operably connected to one of the storage tanks 48 by a pipe or other conduit (not shown) extending between the vat 62 and the tank 48 in order to contain the whey within the tank 48 until such time it is desired to discharge the whey from the tank 48 for various purposes, such as to feed livestock or simply for waste disposal purposes.

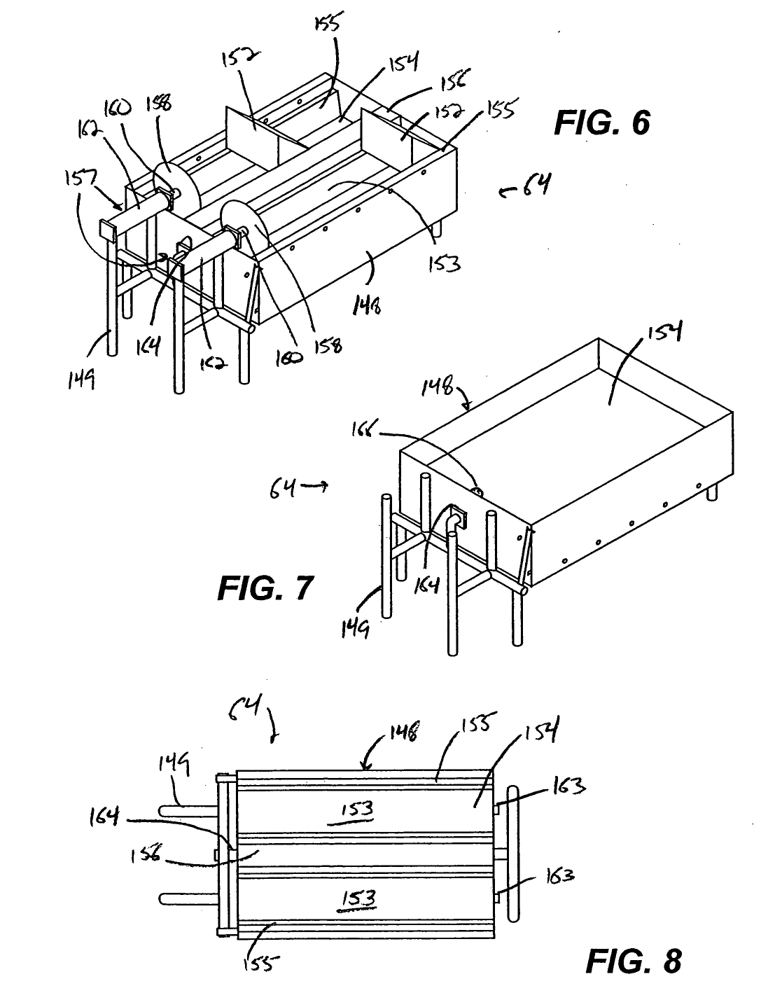

The curd formed in the make vat 62 can then be transferred to the multifunction finishing apparatus or table 64, best shown in FIGS. 6-8. The table 64 includes a central housing 148 that can be moved or pivoted with respect to a supporting base 149 between a drain table configuration 150 or a finishing table configuration 151. As best shown in FIGS. 6 and 8, the finishing table configuration 151 includes a pair of stops 152 removably mounted within channels 153 formed by a central panel 154 extending generally across the housing 148 along a center line for the housing 148, a pair of side guides 155 positioned along each side of the housing 148, and a channel divider 156 positioned between and spaced from each of the guides 155. The stops 152 are adjustably secured to the guides 155 and divider 156, such that the stops 152 can be positioned at various locations along the length of each channel 153. Each of the channels 153 further includes a press 157 located at the end of each channel 153 opposite the stop 152. Each press 157 includes a pressing element 158 operably connected via a shaft 160 to an air cylinder 162 that can be actuated automatically or manually. When curds from the make vat 62 are positioned within hoops (not shown) and positioned between the presses 157 and stops 152, the presses 157 can be operated to expel additional whey from the curd and compress the curd into the desired density for the resulting cheese. The whey expelled from the compressed curd flows through a drain 163 disposed at the end of each channel 153 opposite the press 157. The whey flows to the drain 153 because the central panel 154 is secured within the housing 148 at an angle such that the whey falling onto the panel 154 is directed by gravity to the drain 153 for collection in one of the storage tanks 48 via a pipe connected between the table 64 and the tank 48.

Looking now at FIG. 7, the table 64 is shown configured as a drain table 150 in which the presses 157 have been removed from the supporting base 149, and the central housing 148 has been inverted about a pivot member 164 operably connected to each end of, or extending completely through the central housing 148. In this configuration, the central panel 154 forms a supporting surface on which curds from the make vat 62 that have been positioned within forms (not shown) can be placed, in order to allow whey to drain away from the curd in the forms onto the central panel 154 and through a drain 166 into one of the storage tanks 48, as discussed previously. The cheese made utilizing the table 64 in the drain table configuration 150 may then be removed from the central panel 154 within the forms and positioned within the brine tank 74.

Other configurations for the apparatus 10 are also possible. For example, instead of being configured for use as a cheese-making plant, the trailer 12 can be formed to include equipment (not shown) in the dairy processing area 50 that is utilized to perform other dairy processing functions, such as yogurt making or ice cream making functions, among others. For these purposes, the dairy processing area 50 is either initially configured with the required dairy processing equipment for these alternative functions, or the cheese-making equipment described previously can be removed and replaced by the equipment required for the different dairy processing function to be performed in the trailer 12. This is possible due to the initial configuration or construction of the trailer 12 to include the various electrical and mechanical systems, described previously, which can readily be connected to various types of dairy processing equipment. Thus, the apparatus 10 formed using the trailer 12 can be configured as desired at any point during of after the initial construction of the apparatus 10, making the apparatus 10 truly modular in construction.

Various alternatives are contemplated as being within the scope of the following claims particularly pointing and distinctly claiming the subject matter regarded as the invention.

What is claimed is:

1. A dairy processing apparatus comprising:
a) a mobile enclosure including at least one pair of wheels and adapted to be secured to a motor vehicle and;
b) a first storage tank connected to the enclosure and adapted to hold either raw or waste material generated by the apparatus;
c) a pasteurizer disposed within the enclosure;
d) a curd-producing device disposed within the enclosure adjacent the pasteurizer; and
e) a finishing table disposed within the enclosure adjacent the curd-producing device.

2. The apparatus of claim 1 further comprising a deck releasably secured to the exterior of the enclosure.

3. The apparatus of claim 2 further comprising at least one opening in the enclosure in alignment with the observation deck.

4. The apparatus of claim 3 wherein the at least one opening is a window.

5. The apparatus of claim 3 wherein the at least one opening is a door.

6. The apparatus of claim 1 wherein the finishing table comprises:
a) a support; and
b) a central member pivotally secured to the support, the central member including a drain table side, and a press table side opposite the drain table side.

7. The apparatus of claim 1 further comprising a brine tank disposed within the enclosure.

8. The apparatus of claim 1 wherein the curd-producing device is operably connected to a second storage tank.

9. The apparatus of claim 1 further comprising a closed loop cooling circuit extending between a cooling unit located within the enclosure and the pasteurizer.

10. The apparatus of claim 9 wherein the cooling unit is operably connected to a storage area disposed within the enclosure.

11. The apparatus of claim 9 further comprising a brine tank disposed within the enclosure and connected to the closed loop cooling circuit.

12. The apparatus of claim 1 further comprising a closed loop heating circuit extending between a water heater disposed within the enclosure and the pasteurizer and the curd-producing device.

13. The apparatus of claim 12 wherein the closed loop heating circuit is connected to the curd-producing device.

14. The apparatus of claim 1 further comprising at least one washing member disposed within the enclosure and connected to a second storage tank.

15. The apparatus of claim 14 wherein the second storage tank is a waste storage tank.

16. The apparatus of claim 14 wherein the at least one washing member is selected from the group consisting of a sink and a wash tank.

17. The apparatus of claim 1 further comprising a water dispensing unit connected to a third storage tank.

18. A method for producing cheese, the method comprising the steps of:
a) providing an enclosure adapted to be secured to a motor vehicle and including at least one pair of wheels, the enclosure including a first storage tank connected to the enclosure, a pasteurizer disposed within the enclosure, a curd-producing device disposed within the enclosure adjacent the pasteurizer, and a multifunction finishing table disposed within the enclosure adjacent the curd-producing device;
b) pasteurizing milk from the first storage tank in the pasteurizer;
c) agitating the milk from the pasteurizer into curds and whey in the curd-producing device; and
d) forming the curds into cheese on the multifunction finishing table.

19. The method of claim 18 wherein the step of forming the curds into cheese comprises the steps of:
a) positioning the finishing table in either a drain table configuration or a press table configuration; and
b) operating the table the expel whey from the curds to form the cheese.

20. The method of claim 18 further comprising the step of placing the cheese in a storage location disposed within the enclosure.

21. A self-contained, modular dairy plant comprising:
a) a mobile enclosure including at least one pair of wheels and adapted to be secured to a motor vehicle; and
b) at least one storage tanks secured to the enclosure; and
c) a first closed-loop fluid circulation system disposed within the enclosure and operably connected to the at least one storage tank, wherein the enclosure includes a dairy processing room having one or more pieces of dairy processing equipment therein operably connected to the first closed-loop fluid circulation system.

22. The plant of claim 21 further comprising at least one heating device operably connected to the first closed-circuit fluid circulation system.

23. The plant of claim 21 further comprising at least one cooling device operably connected to the first closed-circuit fluid circulation system.

24. The plant of claim 21 further comprising a second closed-loop fluid circulation circuit operably connected to the one or more pieces of dairy processing equipment.

25. The plant of claim 21 further comprising an observation deck releasably connected to the enclosure.

26. The plant of claim 21 wherein the dairy processing room is lined with a waterproof material.

27. The plant of claim 21 wherein the one or more pieces of dairy processing equipment disposed within the enclosure and connected to the first closed-loop fluid circulation circuit are selected from the group consisting of pasteurizers, make vats, finishing tables and combinations thereof.
